(19) United States
(12) Patent Application Publication
(10) Pub. No.: US 2026/0084250 A1
(43) Pub. Date: Mar. 26, 2026

(54) A HYBRID WELDING SYSTEM AND METHOD WITH OVERALL ELECTRICAL INSULATION AND THERMAL CONDUCTIVITY AND COOLING

(71) Applicant: WELDOBOT LTD., Eyal (IL)

(72) Inventors: Menachem GILAD, Sde Warburg (IL); Alfonso RUBIN, Moshav Ofer (IL); Guy KIRON, Ganey Tikva (IL)

(21) Appl. No.: 19/139,354

(22) PCT Filed: Oct. 24, 2023
(86) PCT No.: PCT/IL2023/051101

§ 371 Date: Jun. 15, 2025

Related U.S. Application Data
(60) Provisional application No. 63/432,711, filed on Dec. 15, 2022.

(51) Int. Cl. B23K 28/02; B23K 9/08; B23K 9/173; B23K 37/003; H05H 1/28; H05H 1/40

(52) U.S. Cl. CPC B23K 28/02; B23K 9/08; B23K 9/1735; B23K 37/003; H05H 1/28; H05H 1/40

(57) ABSTRACT

A hybrid welding system that comprises a plasma welding unit (Plasma unit) and a MIG welding unit with a non-consumable electrode (cathode) and a consumable electrode, where the electrodes are positioned relative each other so that their respective axes form an angle α so that arcs initiated from the electrodes intersect a workpiece plane to define an impingement point distance D. A gas shielding nozzle forms a confined space around the tips of the electrodes, accommodates and covers them and keeps the angle α between them inside the confined space and impingement point distance D. The Plasma unit comprises thermal cooling means with a channel surrounding the cathode down to the nozzle and tip of the cathode and also the tip of the MIG electrode around the gas shielding nozzle. A heat absorbing fluid circulates inside the cooling channel, especially at the electrodes tips that concentrate the highest amount of heat at highest temperature. Electrically insulating porous ceramic cover and filler surround the cathode. Oval shaped magnetic horns control the distance D and prevent the electrical arcs of the two electrodes from deflecting from and brought closer to each other. This prevents disturbances in the melting pool and controls the deposition rate.

### TECHNICAL FIELD

The present invention pertains to a dual, hybrid (Metal-Inert-Gas) MIG-plasma apparatus for welding. More particularly, the present invention pertains to such apparatus with efficient thermal cooling and electrical insulation that improve welding performance, protect sensitive parts from wear and prolong working life of the apparatus.

### BACKGROUND

A hybrid welding system comprises a Plasma unit (Plasmatron) and a MIG (Metal Inert Gas) welding unit, including a consumable electrode and a non-consumable electrode, positioned so that their respective axes form an acute angle α and that arcs initiated from the electrodes intersect a work piece plane to define an impingement point distance D. A detailed description of such configuration of a dual welding system can be found in U.S. Pat. No. 7,235,758. FIG. 1 illustrates such a system in further detail. 200 is the Plasma unit including a nozzle at the tip of the its torch. 300 is the MIG unit including a nozzle at the tip of its torch. A distance between the arcs that these two nozzles create is identified as D, and acute angle α is the angle between the arcs of the Plasma and MIG welding units. Cross electrical interference between the electrodes of the two welding units is prevented with a magnetic field between them. Such magnetic field may be made of a permanent magnet or an electromagnet. Further, the welding system in U.S. Pat. No. 7,235,785 also has cooling channels that surround the electrodes and are filled with a cooling fluid to cool the cathode of the plasma electrode and an electrically insulating film along this cathode to prevent electrical breakdowns. However, the insulating film covers the body of the cathode of the plasma welding unit and does not extend down to the tip of the torch. The insulating film is used to enable electrical insulation.

It is, therefore, an object of the present invention to provide a dual welding system with an improved magnetic field that generates a constant magnetic field.

It is yet another object of the present invention to provide a dual welding system with an improved cooling configuration that shields the most thermally sensitive parts of the system.

It is yet another object of the present invention to provide a dual welding system with an improved electrical insulation means that prevents electrical breakdowns.

This and other objects and embodiments of the present invention will become apparent as the description proceeds.

### SUMMARY

In one aspect, the present invention pertains to a welding system that comprises a hybrid plasma unit (Plasmatron) and a MIG welding unit, including a consumable electrode and a non-consumable electrode, positioned so that their respective axes form an angle so that arcs initiated from the electrodes intersect a workpiece plane to define an impingement point distance D.

In another aspect, the present invention provides a hybrid welding system that comprises plasma and MIG welding units for coordinated welding of metal workpieces, where the welding unit comprises improved magnetic force, thermal cooling and electrical insulation. These magnetic force, thermal cooling and electrical insulation improve the performance of the welding system, protect its part from accumulated and developing damages such as cracks due to overload heat and prolong its working life and capacity.

In still another aspect, the hybrid welding system comprises a shielding that accommodates and covers the tips of the torches of both the plasma and MIG (GMAW) units without cross interference between the arcs of the plasma and MIG electrodes. The shielding sets a closed space for the tips into which the inert gas is streamed and protects the weld from interacting with air better than a gas streamed around the tips without a cover. At the same time, proper orientation of the torches of the plasma and GMAW units relative each other inside the confined volume of the cover keeps a proper distance between their arcs and prevents cross-interference. This way both objectives are obtained, namely better shielding with inert gas and controlling the relative distance between the arcs, the welding process and the weld quality. In addition, the cover provides the advantage of circulating cooling fluids at its walls that absorb heat from the welding arcs and tip, thereby protecting the cover from deformation.

According to the above, the hybrid welding system comprises one or more dedicated controllers that control an angle ‘α’ between the nozzles/tips of the torch of the MIG and plasma units and the arcs they produce and an impingement point distance ‘D’ in the workpiece. ‘D’ is defined as the distance of penetration of the arcs into the workpiece.

In another aspect, the hybrid welding system of the present invention comprises an algorithm that monitors the actual current and voltage of the plasma and GMAW (MIG) arcs. Based on a desired output from each electrode, a controller synchronizes the magnitude of the magnetic field at the welding point, adjusting the welding arcs stability and penetration in order to receive a qualified weld.

Accordingly, in one embodiment, the dual welding system of the present invention provides thermal cooling that is continuous along the welding torch up to the tips of its nozzles, which is the most sensitive part of the torch and concentrates the highest heat in the welding process. In another embodiment, the shape and location of the magnetic straps and the orientation of the magnetic field that they generate improve the electrical separation between the MIG and plasma welding units and affect the stability of the welding arcs. In still another embodiment, the materials used for thermal dissipation and conductivity may be selected from water and materials known in the art for cooling. Such cooling materials are introduced into a particular configuration of the welding units and the system as a whole, which results in an improved dissipation and thermal conductivity.

The combination of the magnetic field and thermal and electrical insulation in the welding system of the present application will be described in more detail below and its benefits will be clearly shown from the description with reference to the accompanying drawings.

### BRIEF DESCRIPTION OF THE DRAWINGS

FIGS. 1A-B illustrate a front view of a dual/hybrid MIG-plasma welding apparatus and cooling means.

FIGS. 2A-C and 3C illustrate front view of the plasma welding unit and its cooling means.

FIGS. 3A-B illustrate section views of the cooling means at the nozzle tip of the plasma unit in the MIG-plasma welding apparatus. *FIG. 3A shows where the cross section is.

FIG. 4 illustrates a cross section view of the cooling.

FIGS. 5A-C illustrate top, side and section views of the cooling configuration at the shield nozzle.

FIGS. 6A-B illustrate side and cross section views of the shielding nozzle for the plasma unit of the MIG-plasma welding apparatus.

FIG. 7 illustrates the electric insulation of the plasma welding apparatus.

FIG. 8 illustrates a cross-section view of the electrical and heat dissipation in the plasma unit of the MIG-plasma apparatus.

FIGS. 9A-B illustrate the magnetic path of the MIG-plasma apparatus.

FIGS. 10A-B illustrate zoom-in and top views of the magnetic shield of the MIG-plasma apparatus.

FIGS. 11A-B illustrate a cross section of the plasma welding unit showing the thermal dissipation and conductivity and cooling elements.

### DETAILED DESCRIPTION OF THE DRAWINGS

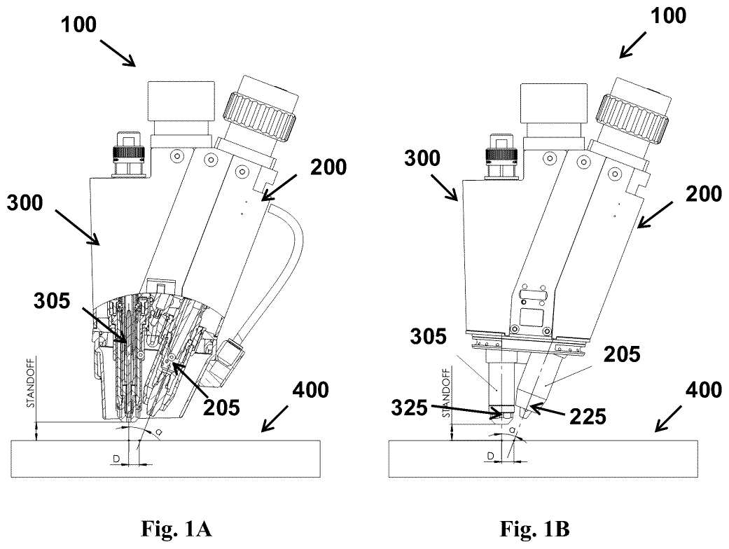

FIG. 1A illustrates a general view of the dual MIG-plasma welding apparatus 100. This apparatus comprises a MIG welding unit 200 and a plasma welding unit 300. Each unit comprises a welding torch that ends with a welding nozzle, 205 and 305 for the MIG and plasma torches, respectively. The welding nozzles end with a welding tip, 225 and 325 for the MIG and plasma units respectively that are located in close proximity to the surface of a workpiece 400. The torches of the MIG and plasma units are oriented at an angle relative each other, which makes an angle α between the welding arcs of the plasma and GMAW, i.e. MIG, welding units. A distance D is defined as the length of an interval on the workpiece, which borders are straight lines extending from the MIG and plasma welding tips, which are angularly oriented relative each other. These two parameters, the angle α and distance D define the orientation of welding of the two welding units.

To obtain a preset fixed impingement point distance D, the hybrid welding apparatus also comprises a controller that controls the magnitude of a magnetic field B, which is coupled to the Plasma unit torch to keep the preset distance D; a controller that controls the magnitude of the electrical current that is delivered through the nozzle of the MIG welding unit, where controlling this electrical current keeps the preset impingement point distance D fixed; and a controller that controls the arc of the Plasma unit to keep the preset impingement point D fixed. All these controllers may be included in a single controller or separate controllers.

Essentially, the controller operates according to an algorithm that monitors the actual current and voltage of the plasma and GMAW (MIG) arcs. Based on a desired output from each electrode, the controller synchronizes the magnitude of the magnetic field at the welding point, adjusting the welding arcs stability and penetration in order to receive a qualified weld.

A dedicated controller is used also to control the angle ‘a’ between the nozzles of the MIG torch and Plasma unit. A dedicated controller is used to control the height different ‘h’ between the nozzles of the MIG and Plasma unit torches.

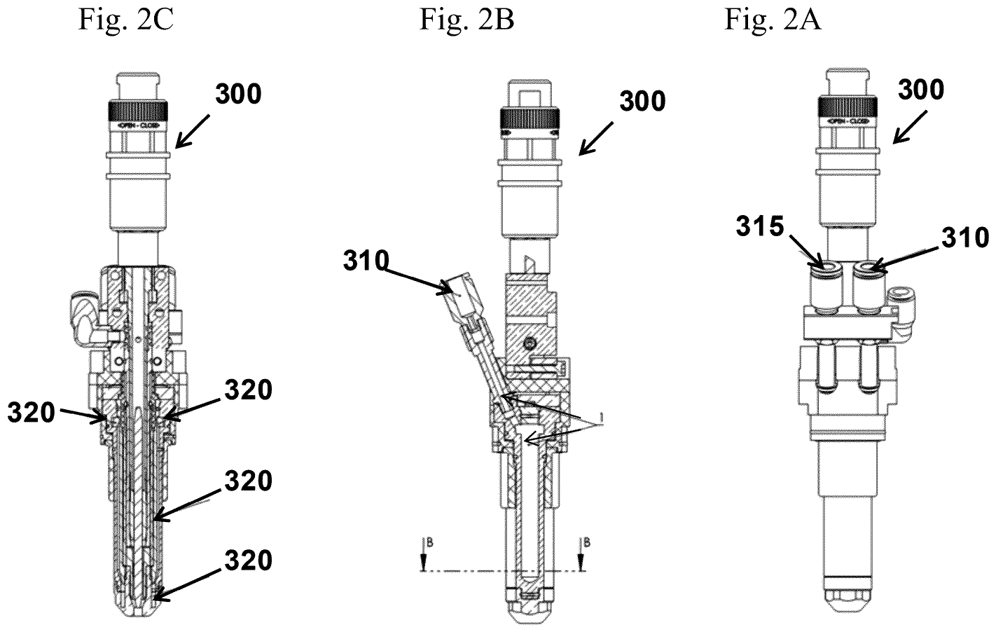

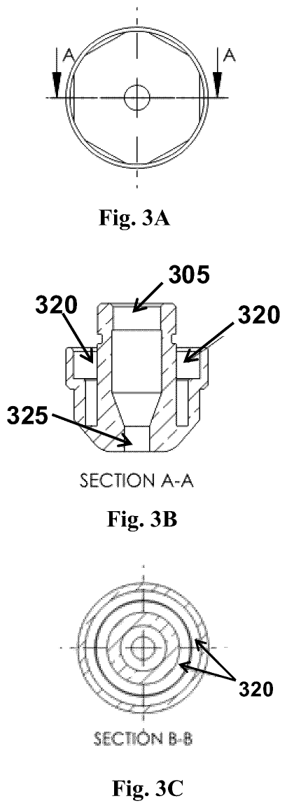

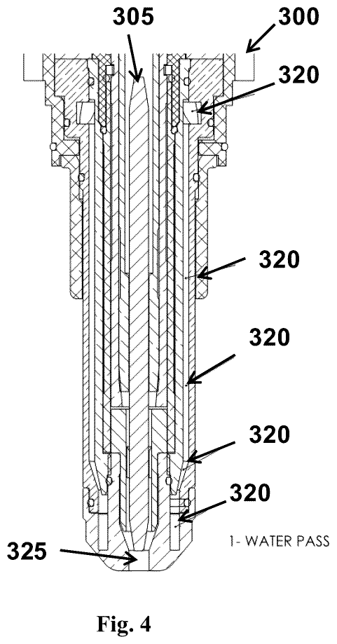

FIGS. 2A-C illustrate front and section views of the plasma welding unit 300 with its thermal cooling parts. Essentially, the cooling is made with water that circulates between inlet 310 for introducing cold water and outlet 315 for letting hot water out that absorbs the heat from the electrode, cathode, 305 (see FIGS. 1A, 4) of the plasma unit and nozzles tips of the Plasma unit and MIG welding torch. The hot water carries the heat out and expels it to the surroundings. Water channel 320 surrounds the cathode 305 along its length and extends from the water inlet 310 along the full length of the cathode down to its nozzle and tip, in which the welding takes place and concentrates the highest amount of heat at the highest temperature. FIG. 2C is a cross section view of the plasma welding unit 300, showing how the water pass reaches the nozzle and tip of the cathode 305, from which the high temperature plasma is released onto the workpiece 400. FIG. 3C is a transverse section view of the plasma welding unit 300, showing the location of the water channel 320 that covers the plasma cathode at the center. FIG. 3A shows a top perspective of the tip of the cathode marking the sectioning plane and direction of view of the sectioned tip. FIG. 3B shows the sectioned tip of the cathode with its thermal cooling configuration in the plasma welding unit. FIG. 3B shows how water circulation in the water pass 320 reaches the tip 325 of the nozzle of the cathode 305. The reduction of heat at this sensitive part that releases very high temperature plasma prolongs its working life and that of the electrode and related sensitive parts and maintains the stability of the welding process. In one embodiment, the distance of the cooling configuration from the nozzle tip is lower than 20, 10, 5 or 3 mm. In still another embodiment, the flow range of water in the cooling configuration is in the range of 0.5-5 L/min. In one particular embodiment, this flow range is 1.8 L/min.

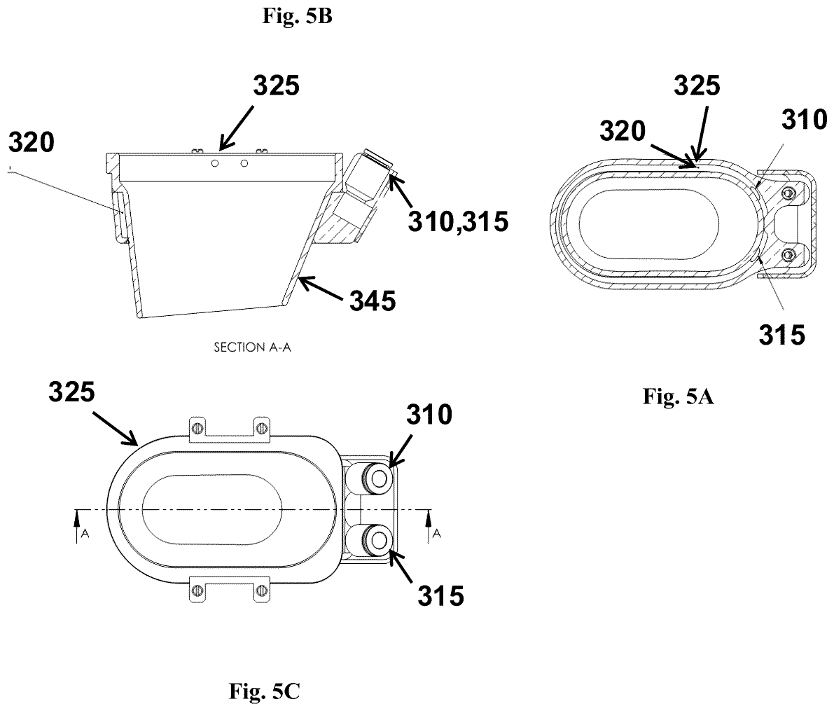

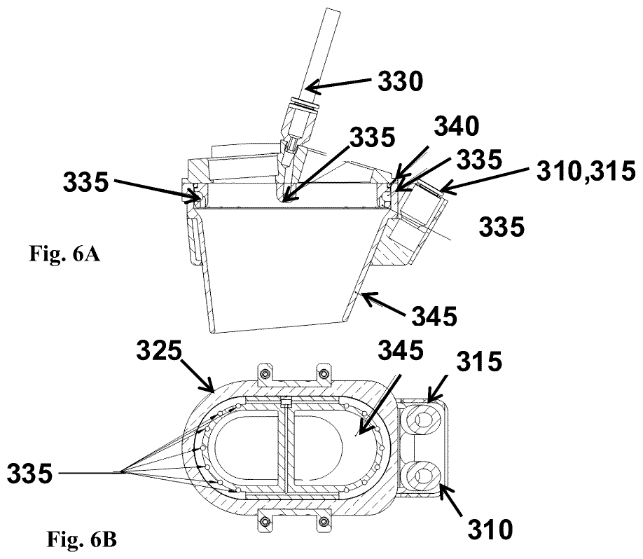

FIG. 4 is an enlarged cross-section view of the thermal cooling configuration in the plasma welding unit. The water circulating along the water pass 320 downstream and upstream reaches the tip of the cathode nozzle 325, absorbs heat from the electrode and expels it to the surrounding. This way it prevents thermally induced cracks in the electrode over time. FIGS. 5A-C show closer views of the thermal cooling configuration at the nozzle 325 of the plasma and MIG welding torches. Specifically, FIG. 5A is a transverse section view, FIG. 5B is a side view and FIG. 5C is a top view of the nozzle with the cooling water circulation 320 at the unit of the nozzle. The inlet of the cold water 310 and outlet of the hot water 315 are located at the sides of the welding unit, letting the water circulate around the nozzle downstream and flow upstream by ensuring constant water flow in the water pass. Gas shielding takes place in nozzle shield 345, as shown in further details in FIGS. 6A and 6B.

Shielding with inert gas is necessary for welding to prevent oxidation of the welding metals in the interaction with oxygen in the air, which generates a porous weld. In addition to the thermal dissipation and conductivity of the welding units of the hybrid system, FIGS. 6A-B illustrate a gas shielding configuration at the nozzle 325 of the plasma and welding unit. This configuration is applied also to the MIG welding unit. Inert gas flows through gas inlet 330 that surrounds the body welding torch of the welding unit until it reaches passes, namely outlets, 335 around the exit of the torch at the torch nozzle 325. These passes are better visualized in the plurality of holes, passes, 335 that surround the nozzle exit. Nozzle shield 345 directs the outgoing inert gas from the plurality of gas passes around a consumable electrode in the MIG welding unit and metal pool in the non-consumable plasma welding unit. O-ring 340 fastens the gas inlet 330 in a stable position to ensure that the gas flows through the gas inlet and passes without trembles. The shield nozzle is used to keep a shielding gas in the region, where the two arcs of the plasma and MIG welding units are combined in one welding torch. Typically the inert gas that is used for shielding is selected from Argon, Carbon Dioxide (CO₂) and any combination thereof.

In one particular embodiment, the hybrid welding system controls the gas flow rate. In particular, the flow rate can be in the range of 0-200 liter per minute. In one particular embodiment, the flow rate is in the range of 15-30 liter per minute.

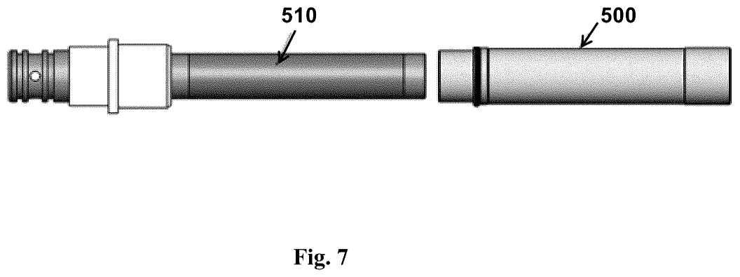

For electrical insulation and thermal dissipation and conductivity, the hybrid welding system of the present invention uses a ceramic layer 500 that covers the welding channel of the plasma welding unit as shown in FIG. 7. This layer comprises internal slits or pores, possibly naturally occurring in its manufacturing process, in which an electrically insulating liquid paste is used as a filler 510 to fill them. The configuration of this combination that integrates the electrical insulation into the thermal insulation is advantageous over other thermal and electrical insulation means such as those that are used in U.S. Pat. No. 7,235,758. This is because U.S. Pat. No. 7,235,758 uses an electrically insulating film that is also highly thermally conductive and its insulation efficiency depends on its thickness. As a result, there should be an optimal film thickness that is sufficient to prevent electrical breakdown and tolerate high working temperature over 200° C. In contrast, the integrated electrical insulation and thermal dissipation and conductivity in the welding system of the present invention uses the inner volume of the porous ceramic cover layer 500 to increase electrical insulation with the liquid paste 510 within the pores and thermal dissipation and conductivity of the ceramic layer itself.

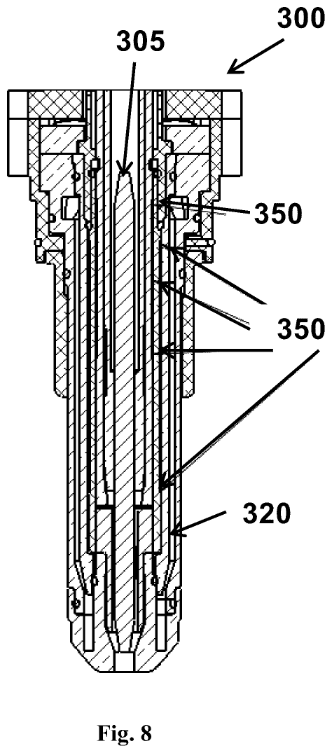

FIG. 8 further details additional locations along and around the cooling channel and cathode, in which the filler paste may also be disposed. Such locations may be the following:
The gap between the inner side of the ceramic layer 500 and the layer around the collet that holds the cathode 305.
The gap between the inner side of the ceramic layer 500 that is in contact with the water cooling pass 320 inside the Plasma unit, i.e. the plasma welding unit.
Around and along the inner and outer diameter of the ceramic layer 500.

In one embodiment, the liquid or paste, which are used as fillers, are thermally conductive dispensable gap fillers. In still another particular embodiment, the material that is used is a two-part silicone liquid gap filler commercially available as TIM-LGF2007.

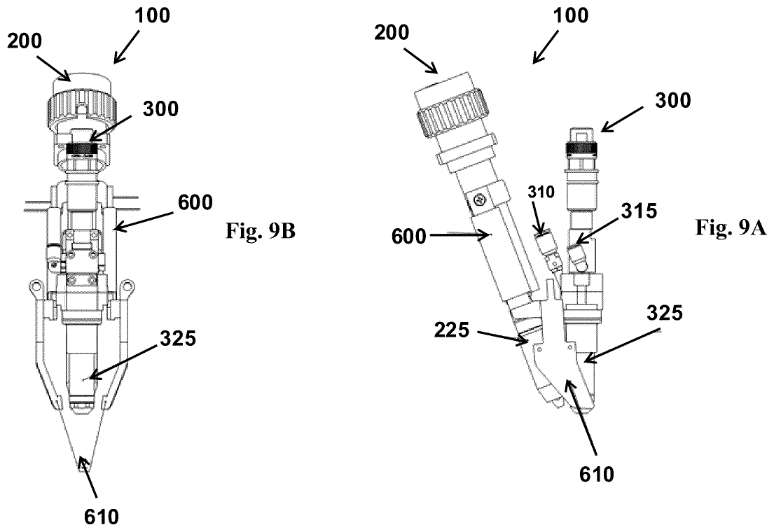

FIGS. 9A-B illustrate a further improvement of the hybrid welding system 100 with a magnetic shielding configuration that enables a narrower overall system configuration. In particular, the magnetic shielding comprises two or more magnetic coils 600 that are placed on the side of the Plasma unit 300 for generating a magnetic field. The magnetic field that these coils generate is directed perpendicularly to the direction of the plasma. Horns 610 are located between the plasma and MIG 200 welding units, which enables to guide the magnetic field toward the place of the plasma arc. The coils 600 have an oval cross section that enables a more uniform magnetic field in proximity of the plasma arc and a narrower overall system configuration.

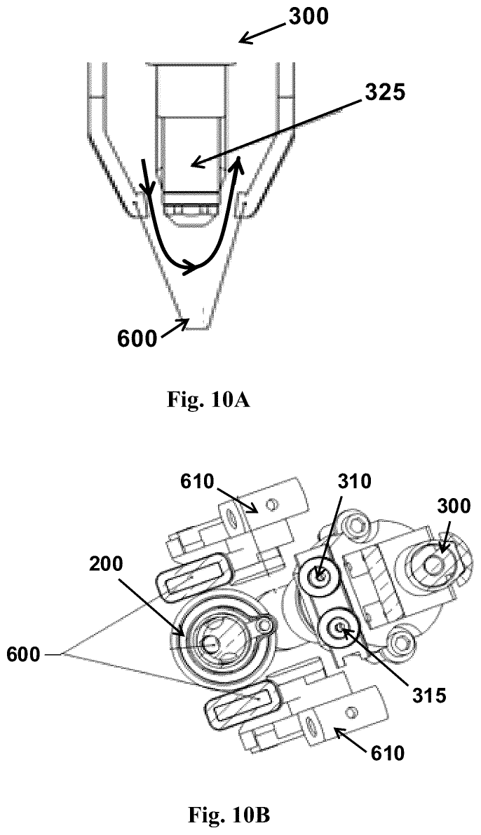

FIGS. 10A-B illustrate top and front closer views of the magnetic shielding of the hybrid welding system. Particularly, the curved arrow in FIG. 10A shows the direction of the magnetic field perpendicular to the plasma arc. FIG. 10B shows top view of the arrangements of magnetic horns 610 and coils 600 that generate the magnetic field affecting the plasma arc, regulate the magnetic field for amplifying the arcs for accelerating welding and prevent electrical outbreak between them. The oval-shaped magnetic horns control the distance D and prevent the electrical arcs of the two electrodes from deflecting from and brought closer to each other. This prevents disturbances in the melting pool and controls the deposition rate.

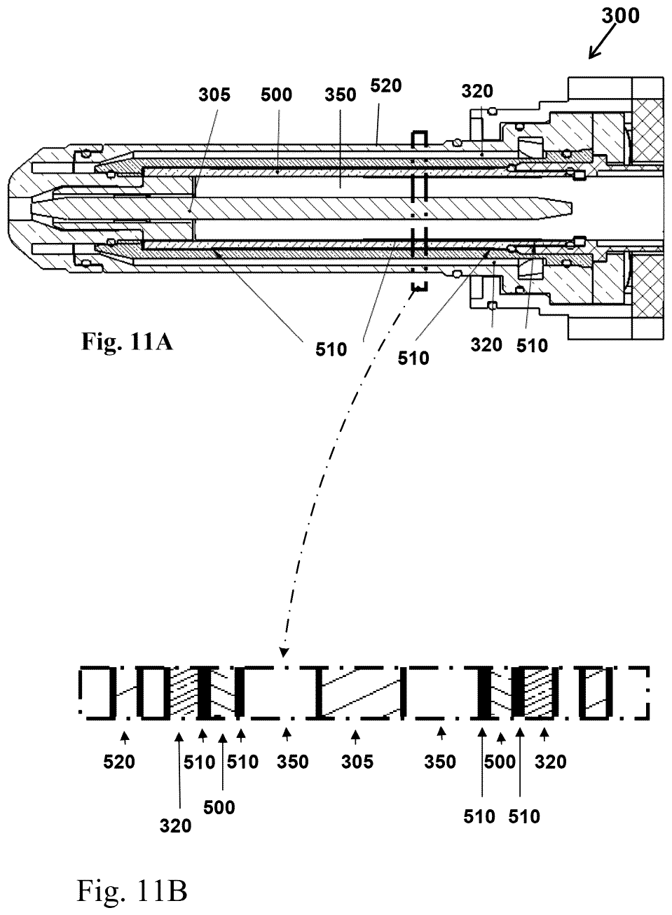

FIGS. 11A-B summarize the main thermal and electrical layers and cooling circulation of the Plasma unit in the hybrid welding system of the present invention. Specifically, FIG. 11A is a cross-section of the Plasma unit 300 configuration showing its layer order. The outer layer is the external cover 520, where the electrode 305 is at the center of the welding torch of the plasma unit 300. Between them in inside out order are the inner body 350 of the torch, the ceramic cover 500 and filler 510 and the water cooling channel 320. FIG. 11B is transverse section view of the Plasma unit 300, also showing its layer order around the circumference of the welding torch. This configuration ensures efficient electrical insulation combined with electrical insulation with the ceramic cover and filler at the inner layers of the welding torch, and expelling of the remaining heat to the surroundings with cold water circulation in the water cooling channel at the outer layer that surrounds the ceramic cover and filler.

1. A hybrid welding system comprising a plasma welding unit (Plasmatron) and a MIG welding unit, said plasma unit comprising a non-consumable electrode (cathode), said MIG welding unit comprising a consumable electrode,
wherein said non-consumable and consumable electrodes are positioned relative each other so that their respective axes form an angle α so that arcs initiated from said electrodes intersect a workpiece plane to define an impingement point distance D.

2. The hybrid welding system according to claim 1, wherein said plasma welding unit comprises thermal cooling means, said cooling means comprises a channel surrounding said cathode along its length and extending from inlet of said thermal cooling channel along full length of said cathode down to said gas shielding nozzle surrounding said tips of said cathode and MIG electrode and up to outlet of said thermal cooling channel, and a heat absorbing fluid circulating inside said thermal cooling channel, wherein welding takes place and concentrates highest amount of heat at highest temperature at said tip of said cathode and said tip of said MIG welding unit.

3. The hybrid welding system according to claim 2, wherein said thermal cooling channel is located inside said shielding cover.

4. The hybrid welding system according to claim 3, wherein said thermal cooling channel comprises a thermal cooling pass surrounding said gas shielding nozzle, wherein said thermal cooling pass is in fluid contact with said inlet and outlet of said thermal cooling channel.

5. The hybrid welding system according to claim 4, wherein distance of said cooling pass from said tips is lower than 20 mm.

6. The hybrid welding system according to claim 4, wherein distance of said cooling pass from said tips is lower than 10 mm.

7. The hybrid welding system according to claim 4, wherein distance of said cooling pass from said tips is lower than 5 mm.

8. The hybrid welding system according to claim 4, wherein distance of said cooling pass from said tips is lower than 3 mm.

9. The hybrid welding system according to claim 2, wherein flow range of said heat absorbing fluid inside said channel is in the range of 0.5-5 L/min.

10. The hybrid welding system according to claim 2, wherein said flow range of said heat absorbing fluid inside said channel is 1.8 L/min.

11. The hybrid welding system according to claim 2, wherein said heat absorbing fluid is water.

12. The hybrid welding system according to claim 1, further comprising a gas shielding nozzle forming a confined space around tips of said non-consumable and consumable electrodes, said gas shielding nozzle accommodates and covers said tips and is configured to keep said angle α between said electrodes inside said confined space and said impingement point distance D.

13. The hybrid welding system according to claim 12, wherein said gas shielding nozzle is configured to keep a shielding gas in one region where arcs of said plasma welding unit and MIG welding unit are combined in one welding torch.

14. The hybrid welding system according to claim 12, wherein gas used in said gas shielding nozzle is selected from Argon, CO₂ (Carbon Dioxide) and combination thereof.

15. The hybrid welding system according to claim 12, wherein flow rate of gas in said gas shielding nozzle is in the range of 0-200 liter/min.

16. The hybrid welding system according to claim 15, wherein flow rate of said gas in said gas shielding nozzle is in the range of 15-30 litter/min.

17. The hybrid welding system according to claim 1, wherein said plasma welding unit comprises electrical insulation means, said electrical insulation means comprises a porous ceramic layer, said ceramic layer surrounding said cathode, and an electrically insulating filler inside pores of said ceramic layer.

18. The hybrid welding system according to claim 17, wherein said porous ceramic layer comprises internal pores and slits.

19. The hybrid welding system according to claim 18, wherein said internal pores and slits occur naturally in manufacturing of said porous ceramic layer.

20. The hybrid welding system according to claim 18, wherein said electrically insulating filler is a thermally conductive dispensable gap liquid or paste.

21. The hybrid welding system according to claim 20, wherein said electrically insulating material is a two-part silicone liquid gap filler commercially available as TIM-LGF2007.

22. The hybrid welding system according to claim 17, wherein said electrically insulating filler is further disposed in a gap between inner side of said porous ceramic layer and layer around a collet holding said cathode, a gap between said inner side of said porous ceramic layer in contact with said channel and said channel in said Plasma unit, and around and along inner and outer diameters of said porous ceramic layer.

23. The hybrid welding system according to claim 1, further comprising two or more magnetic coils placed between said plasma welding unit and said MIG welding unit.

24. The hybrid welding system according to claim 23, wherein said magnetic coils are two magnetic horns, said magnetic horns are configured to guide said magnetic field toward location of arc of said plasma welding unit.

25. The hybrid welding system according to claim 24, wherein said magnetic field is directed perpendicularly to direction of plasma that said plasma welding unit generates, said magnetic horns are configured to guide said magnetic field toward place of said plasma arc and regulate said magnetic field for amplifying said arcs for accelerating welding and prevent electrical outbreak between said arcs.

26. The hybrid welding system according to claim 24, wherein said magnetic horns are configured to regulate said magnetic field for amplifying said arcs for accelerating welding and prevent electrical outbreak between said magnetic horns, control said distance D, prevent said electrical arcs of said two electrodes from deflecting from and brought closer to each other, prevent disturbances in a melting pool that said electrodes generate and control deposition rate of said weld.

27. The hybrid welding system according to claim 23, wherein said magnetic coils have an oval cross section, said oval cross section enabling improved uniformity of a magnetic field that said magnetic coils generate in proximity of arc which said plasma welding unit generates and overall narrower system configuration.
